(19) United States
(12) Patent Application Publication
(10) Pub. No.: US 2002/0096841 A1
(43) Pub. Date: Jul. 25, 2002

(54) Integrated shock absorber and air suspension system

(76) Inventor: William E. Hedenberg, Taylorsville, KY (US)

Correspondence Address: Leo J. Aubel, 111 Rivershire Lane, Lincolnshire, IL, 60069, US

(21) Appl. No.: 10/050,482

(22) Filed: Jan. 16, 2002

Related U.S. Application Data
(60) Provisional application No. 60/263,726, filed on Jan. 25, 2001.

(51) Int. Cl. B60G 17/00

(52) U.S. Cl. 280/6.159; 280/124.157

(57) ABSTRACT

An air suspension system for light to medium duty vehicles. The system includes pneumatically controlled and hydraulic operated shock absorbers. The shock absorbers for the vehicle are adjusted and tuned to be operated in conjunction with the air springs for the vehicle; and, the shock absorbers and the air springs are supplied from the same air supply source.

The present invention claims the benefit of the filing date of provisional patent application Ser. No. 60/263,726 filed on Jan. 25, 2001 the same inventor.

### BACKGROUND OF INVENTION

The present invention relates to an air suspension system of the type disclosed in U.S. Pat. No. 4,518,171, issued to the same inventor herein, that is directed to improving the quality and stability of the ride of vehicles, and which maintain the vehicle level during acceleration and deceleration. U.S. Pat. No. 4,518,171 disclosed an air suspension system having a pair of torque rods that were pivotally attached to the axle housing and extended forward of the rear axle in a modified parallelogram linkage. The air suspension system included a lever arm extending rearwardly of the axle. The forward end of the lever arm was mounted underneath the axle and the rear end of the lever arm was pivoted on a shackle hanger assembly. An air bag was mounted on the lever arm, and the air bag supported the load on the vehicle. The system of U.S. Pat. No. 4,518,171 operated satisfactorily and the disclosure therein concerning the operation of the torque rods as disclosed therein is incorporated herein by reference.

However, the frequency response of the system and the quality of the ride for the vehicle still needed improvement. It has been found that it is important that the shock absorbers of the vehicle be integrated with, and operated and closely controlled in conjunction with, the air suspension system to obtain a high quality ride of the vehicle. U.S. Pat. No. 5,351,986, also issued to the same inventor herein, disclosed improvements to U.S. Pat. No. 4,518,171 wherein the air spring was mounted on a leaf spring and included a single torque rod.

U.S. Pat. No. 5,632,471 titled “Air Suspension System of a Motor Vehicle With Air Shocks Or Air Spring With A Compressed Air Container In The Air Suspension System” is a system wherein sources of air are supplied to both the shocks and the air springs.

Hydraulically controlled shock absorbers are shown in such patents as U.S. Pat. No. 4,726,453 titled “Self-adjusting Single or Twin-tube Shock Absorber”, and U.S. Pat. No. 5,113,980 titled “Quick Response Adjustable Shock Absorber And System”. Pneumatically controlled shock absorbers are available from commercial sources, one such source is Rancho Suspensions of Long Beach, Calif.

### SUMMARY OF INVENTION

An air suspension system for vehicles such as vans, pick-up trucks, or ambulances wherein the air springs for the rear axle of the vehicle and the shock absorbers for the vehicle are operated in conjunction with each other. Air under pressure is coupled to the air spring and to the shock absorbers. Suitable height controls determine the pressure to apply to the air springs and suitable air (pneumatic) control valves determine the pressure to be applied to the shock absorbers, i.e., the shock absorbers are controlled by same air supply source that supplies the air springs.

The foregoing features and advantages of the present invention will be apparent from the following more particular description of the invention. The accompanying drawings, listed herein below, are useful in explaining the invention.

### DESCRIPTION OF THE DRAWINGS

FIG. 1 shows a side view of a vehicle (a pick-up truck) with the preferred embodiment of the inventive air suspension system installed thereon;

FIG. 2 shows a schematic diagram of the integrated shock absorber and air suspension system;

FIG. 3 shows a relatively enlarged side view of the system of FIG. 1, to also show the associated shock absorbers;

FIG. 4 shows a section view of the pneumatic control assembly of one type of shock absorber used in the inventive system;

FIG. 5 shows a relatively enlarged side view of the axle bracket assembly;

FIG. 6 shows an end view of the axle bracket assembly; and,

FIG. 7 shows a partial end view of the rear shackle assembly.

### DESCRIPTION OF THE INVENTION

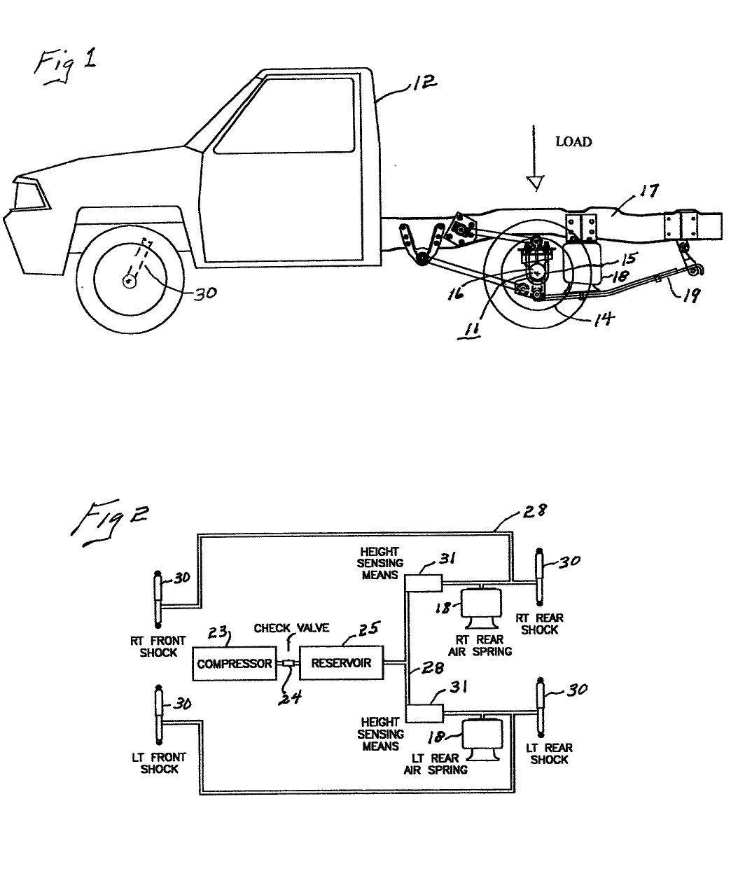

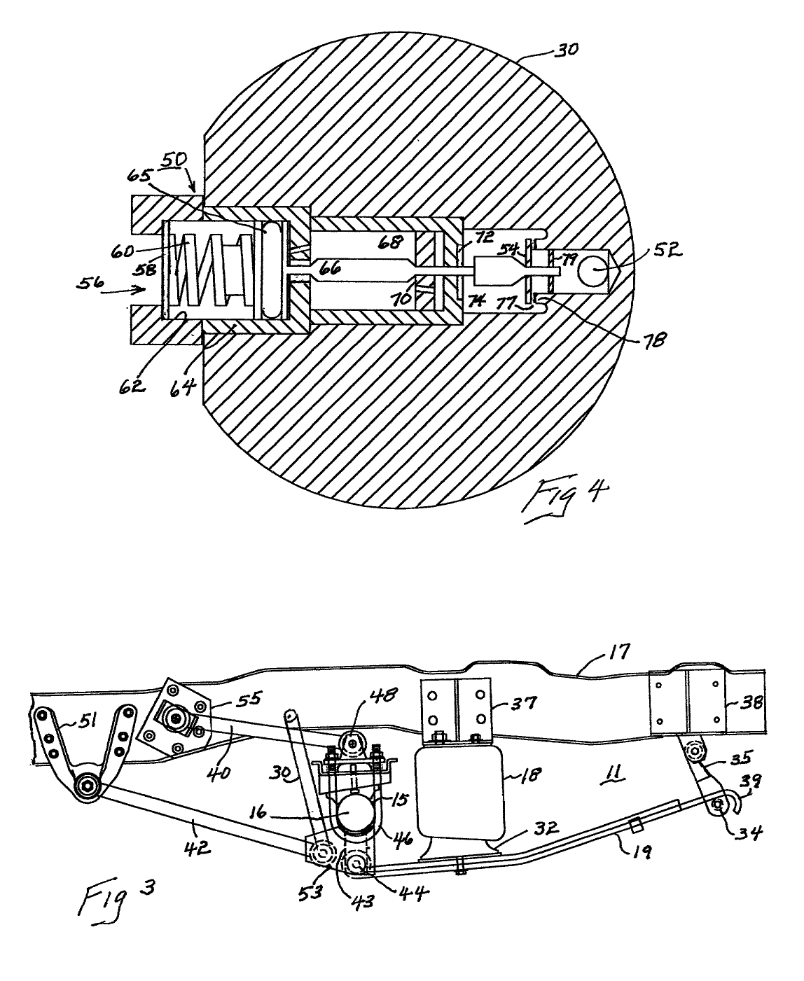

FIG. 1 shows an air suspension system 11 comprising an air spring 18 (see also FIG. 3) that is mounted on a leaf spring assembly 19 and installed on a vehicle such as a pick-up truck 12. The air suspension system is shown as installed on the chassis or frame 17 adjacent the left rear wheel 14 and on the rear axle housing 15 for axle 16 of the truck 12. It will, of course, be understood that a similar air suspension structure which comprises the other, or right, side of the system for the truck is installed adjacent to the right rear wheel on the rear axle housing 15.

FIG. 2 shows a schematic diagram of the air suspension system 11 including the pneumatically controlled hydraulic shock absorbers generally indicated as 30 and also labeled as the rear and front shock absorbers. The shock absorbers 30 are connected to be controlled from the same air supply that comprises a compressor 23, a check valve 24 and a reservoir 25, all of any suitable known design. Shock absorbers 30 are thus pneumatically controlled using by the same air supply that controls the air springs 18.

The shock absorbers 30 of the present invention will now be described with reference to the above drawings. Air from compressor 23, connecting through a check valve 24, is provided to reservoir 25. Air from reservoir 25 and compressor 23 is coupled through suitable air lines, generally labeled as 28, through a known load dependent chassis height sensing means 31 to both the air springs 18 and to the four shock absorbers, generally designated as 30. The shock absorbers 30 include a preselected damping force that is determined by the type of vehicle and the load rating of the vehicle. One type of shock absorber that may be used comprises a modification of a monoflow shock absorber shown in, above cited, U.S. Pat. No. 5,113,980 which discloses a hydraulic controlled shock absorber and system. It has been found that the shock absorber disclosed in said patent can be modified to be controlled by air (pneumatic) means and can be incorporated in the air control suspension system of the invention.

U.S. Pat. No. 5,113,980 is incorporated herein by reference as to the description as relates to the shock absorber per se, and not to the control system as described in the patent.

The modification to the control structure and function of the shock absorber for purposes of the present invention will be explained in detail herein. Various important changes are made to the control structure of the shock absorber disclosed in U.S. Pat. No. 5,113,980 patent: first, the operation of the valve control is essentially reversed; secondly, the control is pneumatic instead of hydraulic; third, the control pressure is applied to a different section of the control assembly; and four, the pneumatic pressure becomes the primary control for setting the response of the shock absorber.

Refer now to FIG. 4, which is in outline somewhat similar to FIG. 3 of U.S. Pat. No. 5,113,980 which discloses a shock absorber with hydraulic (fluid) control. In contrast, the present invention utilizes a pneumatic control assembly, shown in FIG. 4, to set the response characteristics of the shock absorbers to operate in conjunction with the air springs 18 which, in turn, operate in a manner dependent on the vehicle load.

The control assembly 50 structure of shock absorber 30 includes a main valve 52 for the hydraulic fluid used in the shock absorber, and valve plate 54 that provide a selected restriction for the working hydraulic fluid in the shock absorber and thus regulates the operation of the shock absorber. The valve 52 is the only significant flow restriction for the working hydraulic fluid as it moves between the operating chambers of the shock absorber, all as explained in U.S. Pat. No. 5,113,980. The present invention provides a pneumatic control assembly 50 for controlling the force on valve plate 54 and thus the restriction provided by the valve 52. More specifically, the air pressure provided to the control assembly 50, in turn, regulates the “fine” positioning of the valve plate 54 and thus of the valve 52 which in turn controls the effective hydraulic forces within the shock absorber 30. The same air pressure provided to the air springs 18 is provided to the shock absorber 30; therefore, there is a close working relation between the operation of the air springs and the shock absorbers.

Refer now to the components shown in FIG. 4. As stated above, the control assembly 50 utilizes the same source of air that supplies the air springs 18 to control the operation of the shock absorbers 30, see FIG. 2. The port 56 of the shock absorber 30 is coupled to the air lines 28, by any suitable means. The selected air pressure (as determined by the height sensing means 31) is effective on the plate 58 acting on a coil spring 60 that is mounted in a cylinder 62. The opposite end of spring 60 abuts a piston head 64. A suitable O-ring 65 is mounted on head 64 to provide the known sealing properties. The piston head 64 includes a center rod or shaft 66 extending through a second cylinder 68 and to a vented piston 70 on which the shaft 66 is mounted. The shaft 66 extends through the end of cylinder 68 through suitable seals 72 into a third chamber 74 which connects to the hydraulic fluid chambers of the shock absorber 30; i.e., the operating hydraulic chambers as described in said cited U.S. Pat. No. 5,113,980. The distal end of the shaft 66 is supported on a suitable perforated carrier 79 that permits fluid flow there through. The valve plate 54 is mounted adjacent the end of shaft 66 and provides a predetermined gap 77 between it and a mating rim 78 to enable hydraulic fluid to pass through valve 52 into chamber 74. The gap 77, once set by a given air pressure determined by the height sensing means 31, remains in that position until reset. Note that the cylinders and pistons of control assembly 50, shown in FIG. 4, do not slide back and forth continuously, rather when the air pressure is applied to coil spring 60, the control assembly 50 is set.

During normal operation, the coil spring 60 biases the valve plate 54 with a preselected nominal force. The force of the air, at a preselected level of pressure from lines 28 is transmitted via spring plate 58 against coil spring 60 to provide an additional preselected measured force to add to the biasing force of the coil spring 60; this combined force acts against the valve plate 54 of the control the valve 52. This provides a preselected biasing force to the control valve 52, which as mentioned above is the main control valve for the hydraulic chambers of the shock absorber 30 (see the down tube 36 shown in FIG. 2 of U.S. Pat. No. 5,113,980 reference herein). The less restriction of oil flow in a shock absorber 30, the less shock absorber 30 dampens the axle travel: this, in turn, results in a proper ride. Thus, the lower the air pressure provided by compressor 23 and reservoir 25 through lines 28 to the air springs 18 and shock absorbers 30, the softer the ride. Conversely when a high air pressure is provided on lines 28, the control assembly 50 responds to narrow gap 77 of control plate 54 to provide a higher restriction to the working hydraulic fluid in the shock absorbers 30, thus causing the shock absorbers to provide higher dampening of the vertical movement or the associated axle.

In one embodiment, coil springs 60 of three different coil compression ratings are available and a selection is made of which spring to use dependent on the type of vehicle and load to be accommodated. It should be understood that the front shock absorbers 30 of the vehicle will be set for a different loading than the rear shock absorbers 30, such as by using coil springs 60 of different compression ratings.

In an alternative embodiment, the control air pressure may be provided through a port which would lead directly to center chamber 68 of control assembly 50 and to the relatively opposite side of the coil spring 60. The coil spring could be biased to keep the valve plate open, and as the air pressure is increased the valve plate 54 would be effective to narrow the gap 77 that controls the working hydraulic fluid. This can be readily accomplished by creating a gap 77 which is effective behind the valve plate 54 rather than the front gap as shown in FIG. 4.

As will be discussed further, the shock absorbers are selected or tuned to provide desired damping characteristics. While the air pressure required at the shock absorbers could be mathematically calculated, it has been found preferable to empirically “fine tune” or adjust the shocks absorbers by actually feeling the ride of the vehicle and determining the particular adjustments to be made. By feeling the ride, precise adjustments can be made to the air pressure and valving for the air springs 18 as well as for the shock absorbers 30 to provide a softer or stiffer ride under various conditions as desired.

It has been found that, for example, that a pick-up truck as shown in FIG. 1, with original equipment from a manufacturer (OEM) having steel spring suspensions with OEM shock absorbers, has a natural frequency at the rear axle of the truck of 180 cpm (cycles per minute), as measured in an unloaded condition. As is known, the lower the frequency, the softer and smoother the ride.

An improvement to the frequency is provided by the air suspension system as disclosed in this inventor's U.S. Pat. No. 5,351,986. The system of U.S. Pat. No. 5,351,986 using a selected air spring (a Firestone type SN-6) and with OEM hydraulic shock absorbers has a rear axle frequency of 156 cpm.

A further and major improvement is provided by the present invention. The system of the invention when using the same air spring (a Firestone SN-6 air spring) controlled in combination with shock absorbers by the same air supply reduces the axle frequency of the system to 108 cpm. Thus there is a reduction of the rear axle frequency (in the unloaded condition), from 180 cpm with an OEM equipped vehicle, to 108 cpm with the same vehicle equipped with the inventive system; i.e., there is a 40% reduction in rear axle frequency.

As noted above, the adjustment or tuning of the shock absorbers could be done by computer calculation; however it has been found that empirically tuned (adjusted) shock absorbers give better results. It should be understood that tuning is be done for each particular type shock absorbers to be used with a given type of air spring on a given type vehicle with a given load rating. Once tuning is done for a particular unit, the same adjustment or parameters are used for other shocks absorbers for the same use or application.

For purposes of the tuning procedure, test shock absorbers are constructed to be suitable for disassembly (termed “take apart”) such that the damping and/or valving of the shock absorbers can be varied and adjusted so that the damping and valving can be established. This is common practice. (The settings and valving for the production shock absorbers are obtained from the tuning data.) To initiate the tuning procedure, the air suspension system is adjusted to be free of friction in a vertical direction; i.e., all of the pivot points of the air suspension system 11 are loosened, and the shock absorbers 30 are disconnected. With the pickup truck 12 (or other vehicle which will be using the inventive system) in an empty or unloaded condition, the height control sensors 31 are adjusted to set the vehicle at a desired ride height. A person of average weight activates the air suspension system 11 by standing on the rear of the pickup truck 12 and jumping up and down on the rear of the pickup to bounce (cycle) up and down to cause vertical movement throughout the suspension system structure. (Other means of causing vertical movement are obvious.) The cycles are counted and timed. In one test of the system, the unit was cycled for ten second and 14 cycles were recorded. This gave an axle frequency of (6×14) or 84 cycles per minute (84 cpm) for the pickup truck Shown in FIG. 1.

To determine the vehicle's natural frequency at a maximum rated load, the vehicle is loaded to its maximum specified capacity and the frequency test procedure outlined above is repeated. It is well known that the natural frequency will decrease as the load is increased. The natural frequency of the pickup truck 12 of FIG. 1, and at a maximum load of 6,000 pounds on the rear of the pickup, the natural axle frequency was 70 to 72 cpm.

The valving of the test shock absorbers 30 is adjusted on a test bench pursuant to the foregoing frequency data to control the bounce and jounce characteristics. It has been found that with the air suspension system 11, and the pickup unloaded, the average air pressure in the air springs 18 is around 30 psig, and at maximum load, the air pressure is around 100 psig. At 30 psig, the shock absorbers are providing minimum damping to the vehicle axle, thus providing a soft ride. At 100 psig, the shock absorbers will be damping the vehicle maximum load. The air springs 18 and shock absorbers 30 are designed to operate well throughout this range of air pressure of 30 to 100 psig.

The next step of the tuning process is to tighten or torque the air suspension system pivot points to specified fastener requirements. To establish a base line of the ride test, the front and rear shock absorbers are not connected. With the vehicle unloaded, the vehicle is driven over a selected road course and various vehicle axle movements are recorded.

Next, the front shock absorbers are connected to the vehicle and air lines from a dual regulator with air gauges is supplied with air from the air suspension system compressor 23 and reservoir tank 25 and the test drive is repeated. The shock absorbers 30 will deliver minimal damping without any air being supplied; the test results are recorded. Using the regulator and gauges, air pressure of 30 psig (identical to that with the air springs 18 unloaded) is applied to the shock absorbers 30, and the test course is repeated. Adjustments are made to the valving of the shock absorbers 30 as required to provide a desired ride. The vehicle is again driven over the test course to adopt or modify any corrections, dependent on the ride experienced by the tester.

The procedure is then repeated for the rear shock absorbers 30. Note, that the front and rear shock absorbers 30 will now be connected to the system.

Next, the entire test procedure is performed with the vehicle in the loaded condition. As stated above, the test procedure is performed for each type of shock absorber utilized for each particular type vehicle. Once obtained, the results and valving for each type shock absorber will be utilized for that type of shock absorbers used for the same type vehicle.

Note that the air pressure provided to the air springs 18 results is proportional to air pressure being provided to the control assembly (valving) 50 of the shock absorbers 30. The valving of the shock absorber, in turn, controls the effective hydraulic forces within the shock absorber. Accordingly, the shock absorbers also dampen the vehicle axle forces directly dependent on the load; there is a close working relation between the settings for the air springs 18 and for the shock absorbers 30.

Load adjustment for the air spring of the vehicle is controlled by a height sensing means 31 of any suitable known type, which senses the height of the vehicle chassis relative to the rear axle. While a single height sensing means is normally sufficient, having a height sensing means mounted on both sides of the vehicle provides more sensitive response, dependent not only on the total load but also on the load distribution.

Refer now to FIG. 3 which is a relatively enlarged view of the air suspension system shown in FIG. 1. The air spring for the system comprises a vehicle air spring (bag) 18 of any suitable known type, and is selected dependent on the load rating of the vehicle. The air spring 18 has its base 32 suitably mounted on, and is supported by, the leaf spring assembly 19 which extends longitudinally of the vehicle and transverse to the rear axle housing 15. The upper end of the air spring is mounted by a suitable bracket 33 to the chassis 17. Assembly 19 comprises one or more leaf springs of spring steel.

The air suspension system 11 is thus installed in what is termed a trailing lever arm position; i.e., the air suspension spring 18 is directly mounted on the leaf spring assembly 19; spring assembly itself is mounted to extend rearwardly of the axle housing 15 (rearwardly relative to the longitudinal orientation of the vehicle). Since the air spring 18 is mounted on a leaf spring assembly 19, the air spring and leaf spring support the weight of the vehicle chassis and the load on the vehicle (indicated by the arrow line in FIG. 1). Thus, the leaf spring assembly 19 is mounted to extend rearwardly of the axle 16 and its front end is pivoted beneath the axle 16. The forward end of the leaf spring assembly 19 includes an eye or loop, as at 43, and is mounted on a bolt and an elastomer bushing 44 which, in turn, is mounted to an inverted U-shaped bracket 45. Bracket 45 is mounted by U-bolts 46 to the axle housing 15. The forward end of leaf spring assembly is thus pivotably mounted beneath the axle housing 15.

The rear end of assembly 19 is supported on an composite roller bushing 34 mounted on a shackle 35, in turn affixed to the chassis 17 by a suitable bracket 38. The side flanges 37 of shackle 35, see also FIG. 7, constrain or cage the end of assembly 19 relative to lateral movement. The rear end of assembly 19, supported on roller bushing 34, provides a limited curvaliner (arc-like) sliding movement of the rear end of the leaf spring assembly as the roller bushing 34 oscillates. The rear end of on the leaf spring assembly includes a bend or hook 41 to cage or prevent the assembly 19 from exiting the shackle 35. The function of the pivoting shackle 35 and the roller bushing 34 is important to reduce the friction between the components, i.e., the friction between the leaf spring assembly 19 and the supporting roller bushing 34 is reduced.

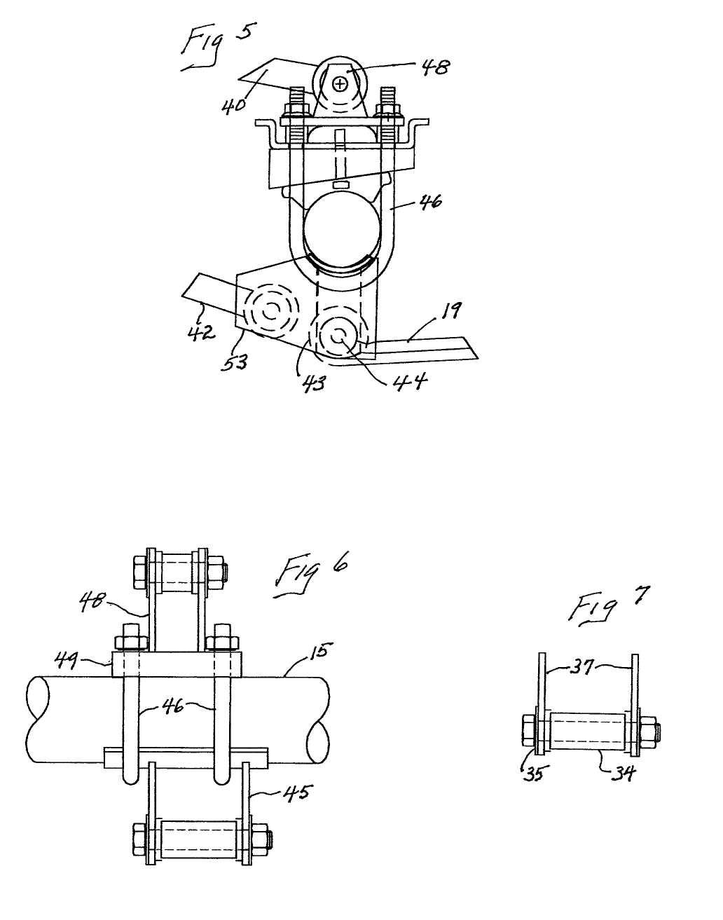

The inventive system 11 further includes two torque rods 40 and 42 that extend forward of the rear axle 16 and the rear axle housing 15. The torque rods 40 and 42 are mounted alongside each other at an angle which diverges from parallel. The torque rods may also be of spring steel, similarly as the leaf spring assembly 19. The forward end of the torque rod 40 is pivotably mounted by a suitable bracket 55 and bushing to the chassis 17. The rear end of the torque rod 40 is mounted to the axle housing 15 by a suitable bracket and bushing 48 which in turn is affixed by U-shaped bolt 46 and associated plate fastener 57 to the axle housing 15, see also FIG. 5. The rear end of torque rod 40 is pivotably mounted to be in a position above, or higher, than the axle and the axle housing 15, as clearly shown in FIGS. 3, 5 and 6.

A second or lower torque rod 42 (torque rod 42 is longer than torque rod 40) extends forward of the rear axle housing 15. The forward end of the torque rod 42 is also pivotably mounted by a bracket 51 and a bushing to the chassis 17. The rear end of the rod 42 is pivotably mounted to bracket assembly 53 which is affixed to the axle housing 15, and the rear end of rod 42 is mounted to be in a position lower that the axle and axle housing. The two torque rods 40 and 42 extend in spaced relation alongside each other. As mentioned above, the two torque rod 40 and 42 are not parallel to each other, but rather the rods extend in a rearwardly diverging angle of seven to nine (7 to 9) degrees.

The torque rods 40 and 42 provide a rearward and downward vector of force on the rear of the vehicle chassis when the vehicle brakes are applied to tend to maintain the vehicle level during braking (nose down action is minimized). Also, the torque rods 40 and 42 provide forward and upward vectors of force on the rear of the vehicle chassis when the vehicle is accelerated and tend to maintain the vehicle level during acceleration (nose up action is minimized). It has been found that the foregoing effects during acceleration and braking are effective if the torque rods 40 and 42 are diverging with respect to with each other rather than being parallel to each other.

As described above, the leaf spring assembly 19 is supported on an composite roller bushing 34 and moves over the bushing which serves as a load-bearing idler roller. The rolling action of the roller bushing 34 minimizes the friction between the two components; this tends to reduce the axle frequency which in turn tends to provide a smoother ride.

In operation, assume the wheel 14 hits a bump and the axle housing 15 moves up; the leaf spring assembly 19 moves up and the base of the air spring 18 is forced up in the air spring bag. In the embodiment shown, the leaf spring assembly 19 has an excursion range of a maximum of about one inch on roller bushing 34. The curvalinear (arc-like) movement of the leaf spring assembly 19, which pivots at its forward end on bushing 44 and at its rear end slides on roller bushing 34, enables the base of the air spring 18 to move up in a relatively more vertical direction in line with the air spring bag. This action further enables the base or piston of the air spring 18 to absorb the bump shock in a truer or straighter line orientation to provide a smoother ride.

In the case where the wheel 14 hits a pot hole, the axle housing goes down. The rear shackle 35 retains the rear end of the leaf spring assembly 19 in position in the shackle and the bend or hook 39 of the leaf spring assembly 19 limits the over-extension of the air spring 18 and of the shock absorber 30; such extension could damage the both components.

The forward torque rods 40 and 42 are pivotably affixed to the axle housing 15. The leaf spring assembly 19 is supported in a sliding manner to the chassis 17. This is in contrast to U.S. Pat. No. 5,351,986 cited above, wherein the two ends of the leaf spring and the the torque rod are secured to respective pivot points and thus constrain movement of the rear axle from multiple longitudinally spaced points.

As noted above, the shock absorbers 30 are selected or tuned to provide desired damping characteristics. The air under pressure to control the valving of the hydraulic shock absorbers is tapped directly from the air supply lines 28 feeding the air springs 18. Thus, the air springs 18 and the shock absorbers 30 are pneumatically controlled by the same source of compressed air.

While the invention has been particularly shown and described with reference to preferred embodiments thereof, it will be understood by those skilled in the art that various changes in form and details may be made therein without departing from the spirit and scope of the invention.

I claim:

1. An integrated air suspension system including shock absorbers and air springs for a vehicle having front and rear axles and front and rear wheels on said axles and axle housings, said said shock absorbers being mounted adjacent said wheels, said air springs being mounted adjacent each wheel on said rear axle housing, compressed air supply means, and height sensors on said vehicle for determining the load on said vehicle for controlling compressed air pressure provided to said air suspension system; said air suspension system comprising in combination,
a) an elongated leaf spring assembly having a forward end and an after end, the forward end of said leaf spring assembly being pivotably mounted to said rear axle housing at a position lower than said axle, and the after end of said leaf spring assembly extending rearwardly of said rear axle housing;
b) a shackle including a roller bushing slidably supporting the after end of each leaf spring assembly to permit limited movement of said leaf spring assembly;
c) air springs mounted on each of said leaf spring assemblies wherein said air springs support the load of the vehicle;
d) an elongated pair of torque rods each having a forward and an after end, said pair of rods positioned adjacent a rear wheel, the rods of each pair being of different length and being mounted adjacent each other in a non-parallel alignment, one of said torque rods extending forward of said rear axle from a position above said axle housing, and the other torque rod extending forward of said rear axle from a position beneath said axle housing; and,
d) said compressed air supply means including air supply lines connected to provide air pressure to said air springs and to said shock absorbers simultaneously to control the damping characteristics of said air springs and said shock absorbers simultaneously.

2. A system as in claim 1 wherein
a) height control sensing means are provided to control the damping characteristics of said shock absorbers and said air springs concurrently.

3. A system as in claim 1 wherein said rear end of said spring assembly includes a bend to prevent said rear end from disengaging from said roller bushing.

4. A system as in claim 1 further comprising
a) a compressed air supply including control valving; and
b) air supply lines coupled to provide compressed from said air supply through said control valving to said air springs and to said shock absorbers to control the damping characteristics of said air springs and said shock absorbers concurrently.

5. An air suspension system as in claim 4 including at least one height control valve responsive to the weight on said vehicle and wherein the compressed air provided to control said shock absorbers is directly related to the compressed air provided to the air springs as determined by said height control valve.

6. An air suspension system for the rear axle of a load carrying four wheeled vehicle said vehicle having a front and a rear axle and respective axle housings mounted on the vehicle chassis that supports a load thereon, said system comprising in combination,
a) elongated leaf spring assemblies each having a forward end and an after end, the forward end of each said leaf spring assembly being mounted to said rear axle housing, and the after end of each said leaf spring assembly extending rearwardly of said rear axle housing;
b) shackles positioned on said frame rearwardly of said rear axle, said shackles each including a roller bushing;
c) the after end of each of said leaf spring of assemblies being slidably mounted and supported on each said roller bushing to permit the after end of each said spring assembly to move back and forth supported on said roller bushing to reduce the friction between said leaf spring assembly and said bushing;
d) an air spring mounted on each of said leaf spring assemblies for supporting said vehicle chassis and the load thereon;
e) pneumatically controlled hydraulic shock absorbers mounted on said frame adjacent said wheels;
f) a compressed air supply including control valving for supplying said air springs and said shock absorbers for regulating said shock absorbers;
g) pneumatic control air supply lines coupled to provide compressed air from said air supply through said control valving to said air springs and to said shock absorbers to concurrently control the damping characteristics of said air springs and said shock absorbers; and,
h) pneumatic control valving in said shock absorber tuned to control the operation of said shock absorber in relation to the compressed air provided to said air spring.

7. In an air suspension system for a vehicle having two axles, said system comprising air springs and shock absorbers, a method of tuning shock absorbers in relation to said air springs comprising the steps of:
a) first adjusting the system to be relatively friction free by loosening pivot points in the system;
b) with the vehicle in an unloaded condition setting a desired height of said vehicle;
c) determining the natural frequency of the associated axle with the vehicle in an unloaded condition, and in a loaded condition; and
d) adjusting the pneumatic control valving of the front shock absorbers to provide a desired type of ride in an unloaded condition, and in a loaded condition; and
e) repeating steps c) and d) for the rear shock absorbers.
